(19) United States
(12) Patent Application Publication
(10) Pub. No.: US 2015/0009666 A1
(43) Pub. Date: Jan. 8, 2015

(54) UNIVERSAL LED LIGHT KIT

(71) Applicant: CORDELIA LIGHTING, INC., Rancho Dominguez, CA (US)

(72) Inventors: James KENG, Rancho Dominguez, CA (US); James MADDEN, Philadelphia, PA (US); Huan C. NGUYEN, Anaheim, CA (US)

(73) Assignee: CORDELIA LIGHTING, INC., Rancho Dominguez, CA (US)

(21) Appl. No.: 14/322,820

(22) Filed: Jul. 2, 2014

Related U.S. Application Data
(60) Provisional application No. 61/842,919, filed on Jul. 3, 2013.

(51) Int. Cl. F21K 99/00; F21V 23/00; F21V 15/01; F21S 8/04

(52) U.S. Cl. CPC F21K 9/1355; F21S 8/046; F21V 23/005; F21V 15/011; F21K 9/54; F21Y 2101/02
USPC 362/235; 362/249.02

(57) ABSTRACT

A universal LED light kit adapted to retrofit or modify a standard ceiling fan having a switch cup, or a ceiling light fixture attached to an electrical outlet box. A LED board having a plurality of spaced apart LEDs is mounted to the exterior of the housing, wherein a LED driver disposed inside the housing powers the LED board. An upper threaded nipple, extension tube, and/or fasteners disposed at the top of the housing connect the kit to the outlet box or the switch cup. A lower threaded, hollow nipple disposed at the bottom of the housing receives a nut or finial to hold the assembly together; attaches a bowl shaped diffuser to the kit; and facilitates a chain pull to pass through to control the fan or light fixture. Electrical wiring passes through the upper nipple and connects the LED driver to the outlet box or the switch cup.

### CROSS-REFERENCE TO RELATED APPLICATION

This application claims priority to U.S. provisional patent application No. 61/842,919, filed Jul. 3, 2013, by the same inventors, the entire contents of which are hereby incorporated by reference.

### FIELD OF THE INVENTION

The present invention relates to an LED light kit. In particular, the present invention relates to a universal LED light kit for installation in an OEM ceiling fan or OEM ceiling light fixture, or retrofitting or converting preexisting ceiling fans and light fixtures to use LED lighting.

### BACKGROUND OF THE INVENTION

Ceiling fans are popular and commonly found in residential homes, restaurants, hotels, businesses, etc. They add an aesthetic appearance to the environment, as well as helping save energy by avoiding use of the air conditioning or heater by cooling or warming the room via room air circulation. To improve consumer appeal, ceiling fans may include a light source to brighten the room and to add ambience, which are important to residential or restaurant lighting, for example. Further, adjustments are available to control the fan rotor speed or to dim the lights. The lighting source used in such ceiling fans are incandescent bulbs, halogen bulbs, and compact fluorescent lights (CFLs).

Residential and commercial establishments have light fixtures that are ceiling flush-mounted or semi-flush mounted, pendant or suspended from the ceiling, for example. These ceiling light fixtures use the same hardware and electrical wiring as with a ceiling fan. They also use incandescent bulbs, halogen bulbs, CFLs, fluorescent tubes, neon lamps, and the like, as the light source.

Currently, for a greener environment, industry movement is toward using Light Emitting Diodes (LEDs) as a light source to replace the incandescent bulbs, halogen bulbs, and CFLs. LEDs dramatically save on power consumption and electricity bills, and their extended duty life of 50,000 hours is a great improvement over conventional light sources that last perhaps a year or two and burn out.

### SUMMARY OF THE INVENTION

The present invention in preferred embodiments is directed to a universal LED light kit adapted for use to retrofit or modify a ceiling light fixture including an electrical outlet box or junction box, or a ceiling fan including a switch cup or like structure, the LED light kit having a housing preferably made from a heat dissipating material, the housing having a flat top and a truncated cone bottom, wherein the cone bottom includes an angled bottom surface with a center opening therethrough. The light kit also includes a LED board having a plurality of spaced apart LEDs, mounted to the angled bottom surface facing away from the housing; a LED driver disposed inside the housing and powering the LED board; an upper threaded, hollow nipple or attachment means disposed at the top of the of the housing connected to the electrical outlet box if used with a light fixture, or connected to the switch cup if assembled to a ceiling fan; a lower threaded, hollow nipple disposed at the bottom of the housing; and electrical wiring passing through the upper threaded nipple and connecting to the electrical outlet/junction box or the switch cup to the LED driver.

In alternative embodiments, the LED light kit may include a bowl shaped reflector attached to the bottom of the housing. A chain pull operating the ceiling fan or ceiling light fixture may be included with the kit, or accommodated if the fan or fixture already has a chain pull, which passes through the bottom nipple. The user or consumer can then still operate the fan or fixture as before the LED light kit was installed. A pan shaped top attached to the bowl enclosing the LED driver is preferred for outdoor use, wherein the pan and bowl enclosure keep inclement weather conditions (snow, ice, rain), dust, spider webs, and insects or rodents way from the electrical LED driver.

### BRIEF DESCRIPTION OF THE DRAWINGS

FIGS. 1(a) and 1(b) show typical ceiling fans and their switch cup designs protruding from the bottom of the fan.

FIG. 2(a) is a typical ceiling fan with a first embodiment of the present invention universal LED light kit attached.

FIG. 2(b) is a side elevational view of the universal LED light kit from FIG. 2(a).

FIG. 2(c) is a bottom view of the universal LED light kit.

FIG. 2(d) is a cross-sectional view of the universal LED light kit taken along line A-A of FIG. 2(b).

FIGS. 2(e) and 2(f) are a lower and upper perspective views, respectively, of the universal LED light kit.

FIG. 2(g) is an exploded view of the of the universal LED light kit.

FIG. 3(a) is a typical ceiling fan with a second embodiment of the present invention universal LED light kit attached.

FIG. 3(b) is a side elevational view of the universal LED light kit from FIG. 3(a).

FIG. 3(c) is a bottom view of the universal LED light kit.

FIG. 3(d) is a cross-sectional view of the universal LED light kit taken along line A-A of FIG. 3(b).

FIGS. 3(e) and 3(f) are a lower and upper perspective views, respectively, of the universal LED light kit.

FIG. 3(g) is an exploded view of the of the universal LED light kit.

FIG. 4(a) is a typical ceiling fan with a third embodiment of the present invention universal LED light kit attached.

FIG. 4(b) is a side elevational view of the universal LED light kit from FIG. 4(a).

FIG. 4(c) is a bottom view of the universal LED light kit.

FIG. 4(d) is a cross-sectional view of the universal LED light kit taken along line A-A of FIG. 4(b).

FIGS. 4(e) and 4(f) are a lower and upper perspective views, respectively, of the universal LED light kit.

FIG. 4(g) is an exploded view of the of the universal LED light kit.

FIG. 5 is a side elevational view, partially in cross-section, of a pendant light fixture retrofitted with one embodiment of the universal LED light kit.

FIG. 6 is a side elevational view, partially in cross-section, of a semi-flush mount light fixture retrofitted with an embodiment of the universal LED light kit.

FIGS. 7(a)-7(c) show various alternative embodiments for the LED light kit in an outdoor ceiling fan application.

FIG. 8 is a side elevational view of a flush-mount ceiling light fixture using the LED light kit.

FIG. 9(a) is an exploded view and FIG. 9(b) is an assembly view of another exemplary embodiment of the universal LED light kit.

### DETAILED DESCRIPTION OF THE PREFERRED EMBODIMENTS

The present invention in various embodiments is directed to a universal LED light kit used by an Original Equipment Manufacturer (OEM) of ceiling fans to incorporate into its new ceiling fan models, or used by a consumer to retrofit or convert a ceiling fan or ceiling mounted light fixture from a conventional incandescent bulb, halogen bulb, CFL, or the like, to a LED light source.

In typical ceiling fan and ceiling mounted light fixture installations, above the ceiling tile, plaster, or drywall slab is an electrical outlet box or junction box covering a hole cut into the ceiling. Inside the junction box are standard three wire leads and this wiring powers the ceiling fan, ceiling light fixture, and the like. A mounting bracket in the form of a metal strip and a threaded metal tube, called a nipple, passing through the center of the bracket together carry the weight of the ceiling fan or ceiling light fixture. Sometimes bolts may be used to help support the weight of the ceiling fan or light fixture in lieu of or in addition to the nipple. The mounting bracket attaches to the bottom of the junction box while the electrical wiring is threaded through the hollow center of the nipple down to the ceiling fan motor or electrical light source of the ceiling light fixture, or the wiring runs down the chain or suspension wire for a pendant light fixture.

The electrical wiring is passed down to a switch cup or switch housing of the fan or ceiling light fixture. In a conventional ceiling fan, the electric motor typically has an annular rotor that rotates about a stationary stator that is at the center. The fan blades are attached to the rotor so when the motor is actuated, the blades spin around the stator. The switch cup at the base of the stator contains electrical connections and a switch or switch circuitry to turn the motor on and off. Depending on design, the fan can be turned on and off by a pull chain connected to the switch/switch circuitry inside the switch cup, or by a wall-mounted toggle switch, or by wireless remote control transmitter. The fan speed and rotation direction can be changed in this manner through processes known in the art using the switch cup circuitry and components. The ceiling fan may have its own light source from incandescent light bulbs, CFLs, halogen bulbs, etc., mounted to the switch cup.

In a ceiling light fixture, the switch cup brings down electrical wiring to the incandescent light bulb, halogen bulb, or CFL mounted below. A decorative glass bowl, canopy, or the like covers the light source and hardware. As with a ceiling fan, a switch inside the switch cup turns the light source on or off, or may dim the light source. These functions can be accomplished using a pull chain connected to the switch, a wall-mounted toggle switch or rotating potentiometer, or via wireless remote transmitter.

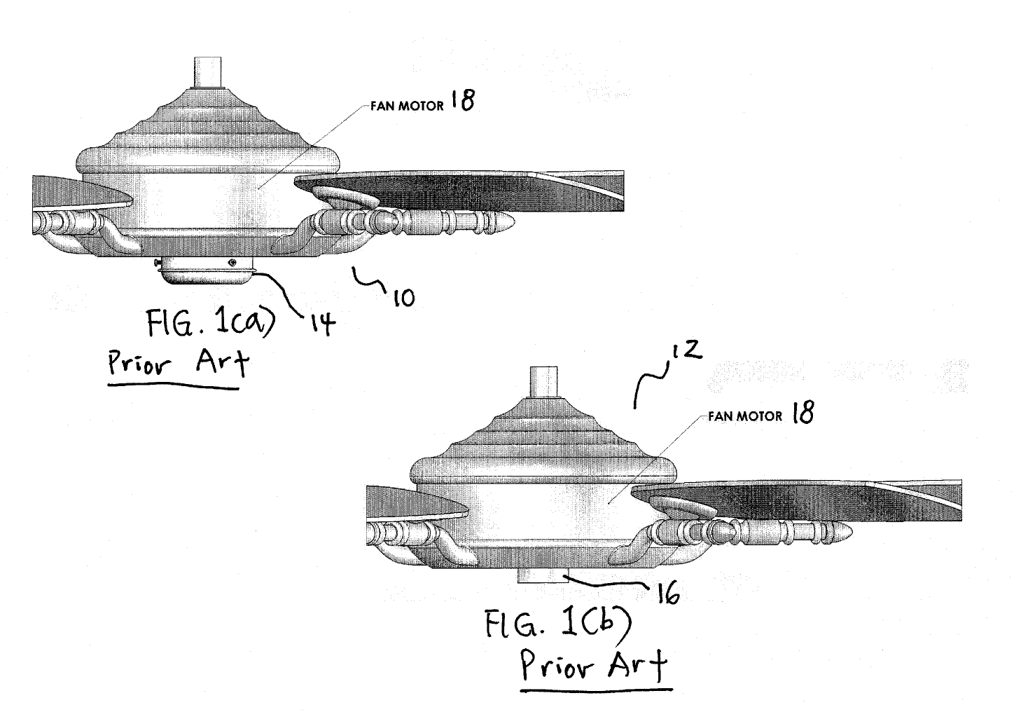

FIGS. 1(a) and (b) illustrate typical ceiling fans 10, 12 found in residential homes and commercial establishments such as a hotel or restaurant. Each fan has a style of switch cup 14, 16 typically found at the base/bottom of the fan at the center axis of the electric motor 18. The switch cup 14, 16 typically extends from the stator portion of the motor along its center axis and does not rotate, while the rotor portion of the motor 18 has fan blades that spin about the stator.

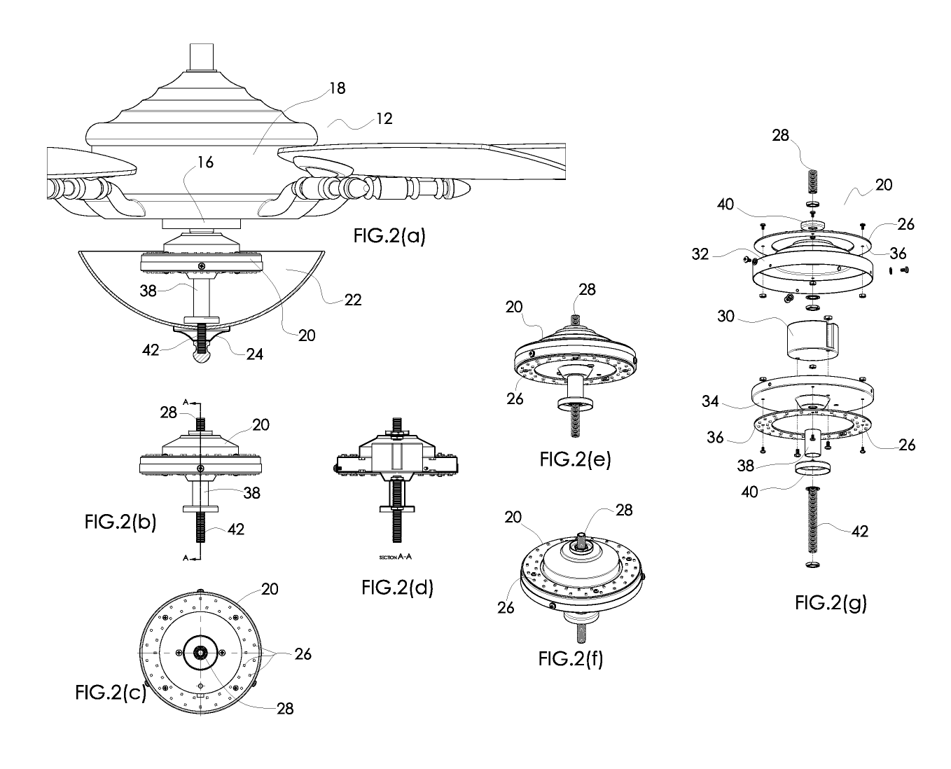

FIG. 2(a) is a side elevational view of a ceiling fan 12 having a first exemplary embodiment of the present invention universal LED light kit 20 mounted to the fan's switch cup 16. Although only two versions of a switch cup 14, 16 are shown in FIGS. 1(a) and 1(b), the present invention LED light kit is adaptable to mount to any iteration of a switch cup found on the market.

As depicted in FIG. 2(a), the universal LED light kit 20 is at least partially covered by an optional light diffuser, light reflector, lens, canopy or the like, proximate thereto or at the bottom. In this embodiment, a glass bowl 22 is selected, and may be part of the LED light kit, or the preexisting bowl of the ceiling fan may be recycled and used.

The glass bowl 22 helps disperse/diffuse the light emitted by the LED light kit 20, and improves the overall aesthetic appearance of the fan/LED light fixture combination. The glass bowl 22 may be of any shape, size, surface contour, exterior decoration, translucency, color, reflectivity, etc., based on intended illumination effect, and may be made from painted or unpainted glass, plastic, porcelain, alabaster, and the like, with or without reflective coating. Thus, the glass bowl 22 diffuses and transmits light downward into the room below and also may reflect light upward toward the ceiling. The glass bowl 22 may have a parabolic shape to help with reflecting the light in a desired pattern. An optional finial 24 provides a finished, decorative look at the bottom as well as helping secure the glass bowl 22 to the kit 20.

FIGS. 2(b) through 2(f) provide different views of the LED light kit 20. In this embodiment, a plurality of LEDs 26 are arrayed in a plane around the center nipple 28 facing upward at the top (up light) and facing downward at the bottom (down light) of the LED light kit 20, as seen in FIGS. 2(e), 2(f). This embodiment employs two rings of LEDs 26, but more rings, unevenly spaced LEDs, more or fewer LEDs, are contemplated. The up light and down light LEDs 26 may be the same pattern and number as shown, or there may be more LEDs or differently arranged pattern of LEDs to provide different lighting effects. Furthermore, each individual LED 26 may be angled in a pattern with others or randomly to project light in its own particular direction. Although not shown, the LEDs may in an alternative embodiment be arranged around the outer circumference or periphery of the LED light kit 20 to face radially outward. Furthermore, in various alternative embodiments, the LED's red-green-blue (RGB) color, color rendering index (CRI), lumens output, Kelvin temperature, and other visible light characteristics may be selected to enhance the light output from the ceiling fan and to complement the visual appearance of the glass bowl 22 and the ceiling fan 12 (e.g., art deco fan style, paint color, shiny or dull finish, fan blade shape, fan blade surface finish or color, etc.).

FIG. 2(g) is an exploded view of the LED light kit 20 showing the major components. At the top is the nipple 28, which is preferably a hollow, metal tube with a threaded exterior. The nipple 28 threads into the typical hardware (e.g., mounting bracket) contained inside the switch cup 16 of an existing ceiling fan 12.

Receiving the opposite, bottom end of the nipple 28 is a driver housing top 32, which covers an LED driver 30 that powers the LEDs 26. Beneath the LED driver 30 is a driver housing bottom 34 and together with the top 32 encloses the LED driver. An annular LED board 36 sits atop the driver housing top 32, and another annular LED board 36 is attached to the driver housing bottom 34, making up the up light and the down light, respectively. In a preferred embodiment, the driver housing top 32 has a pyramid shape and the driver housing bottom 34 has a disk shape. Via empirical observations, the preferred pyramid shape is selected to minimize any shadows cast by the driver housing top 32. So arranged, the LEDs when powered up project light upward and downward creating a specific illumination effect. Indeed, the up light illuminates the ceiling which further reflects the light indirectly, while the down light directly illuminates the room below. The spherical illumination of a typical incandescent bulb, halogen bulb, CFL, is thus duplicated and improved upon using LEDs.

As seen in FIG. 2(g), an optional spacer or extension tube 38 and end caps 40 at the top and bottom of the driver housings 32, 34 along with assorted nuts, screws, and washers hold the entire LED light kit assembly together. The spacer tube 38 along with a threaded nipple 42 at the bottom of the LED light kit 20 enable attachment of the glass bowl 22 to the LED light kit. The finial 24 screws on to the threaded nipple 42. The finial 24 can be unscrewed to remove or replace the glass bowl 22.

The present invention LED light kit may [1] be added to an OEM ceiling fan maker's current models that lack LED lighting; [2] modify the OEM models that were only using incandescent, halogen, CFL or like light source; [3] enable a commercial or residential consumer or electrical contractor to purchase the LED light kits to convert preexisting ceiling fans that lack any lighting; or [4] be used to retrofit preexisting ceiling fans with obsolete light sources. As such, the LED light kit may be sold on its own without a fan. The LED light kits may be likewise applied to ceiling light fixtures aside from fans.

In the exemplary embodiment shown in FIGS. 2(a)-2(g), the LED light kit 20 for new OEM fans, conversion, or retrofit, utilizes the electric switch and related circuitry in the new or preexisting fan's switch cup 16; this is the same electric switch/circuitry used to control the incandescent light bulb, halogen bulb, CFL, or like light source, now removed and replaced by the LED light kit 20. Accordingly, no electrical rewiring, voltage amplifiers or transformers, rectifiers or similar electrical modification is required in the OEM implementation or consumer conversion or retrofit process.

Preexisting wiring and electrical hardware in the new OEM fan or retrofit or conversion fan can be used as well. Although not shown, the electrical wiring from the switch cup 16 is preferably connected to the LED light kit 20 using push-in plastic quick connectors, twister or wire nut type connectors. Wiring from the connectors is threaded through the hollow center of the nipple 28 of the ceiling fan down to the LED driver 30. Thus, the electrical switch/circuitry contained in the switch cup 16 that previously controlled the preexisting incandescent bulb, halogen bulb, or CFL now controls the LED light kit 20 for power on or power off, and the light output intensity of the LEDs (i.e., dimming) in the same fashion. Control of the fan speed and blade clockwise or counterclockwise rotational direction is the same as before via the preexisting electric switch/circuitry inside the switch cup 16. If power on/off of the ceiling fan 12 and its incandescent bulb, halogen bulb, CFL, etc. is by wall mount toggle switch, then the same toggle switch now controls the LED light kit 20. If the electric switch/circuitry is operated by a wireless remote transmitter (via RF, Wi-Fi, or infrared transmission, or the like), then the LED light kit 20 is likewise controlled through electrical connection to the wireless receiver.

Some ceiling fans have a chain pull to control the electric switch/circuitry inside the switch cup 16 to operate the fan 12 and its incandescent bulb, halogen bulb, or CFL. One or more chain pulls pass through the nipple 28, 42 and out through the bottom of the fan/light fixture combination. The user pulls on the chain to control the fan and/or the light source. With the present invention LED light kit 20 retrofit, the chain or chains may pass through the nipple 28, through a center hole in the case enclosing the LED driver 30 or around the side of the LED driver 30, and down and out through the bottom nipple 42. The finial 24 may be omitted, replaced by a lock nut, in this embodiment so that the chain or chains extend out through the bottom of the LED light kit 20, or the finial may have an opening at the bottom through which the pull chains pass. Other embodiments may have the chain or chains passing loosely along the side of the LED light kit 20.

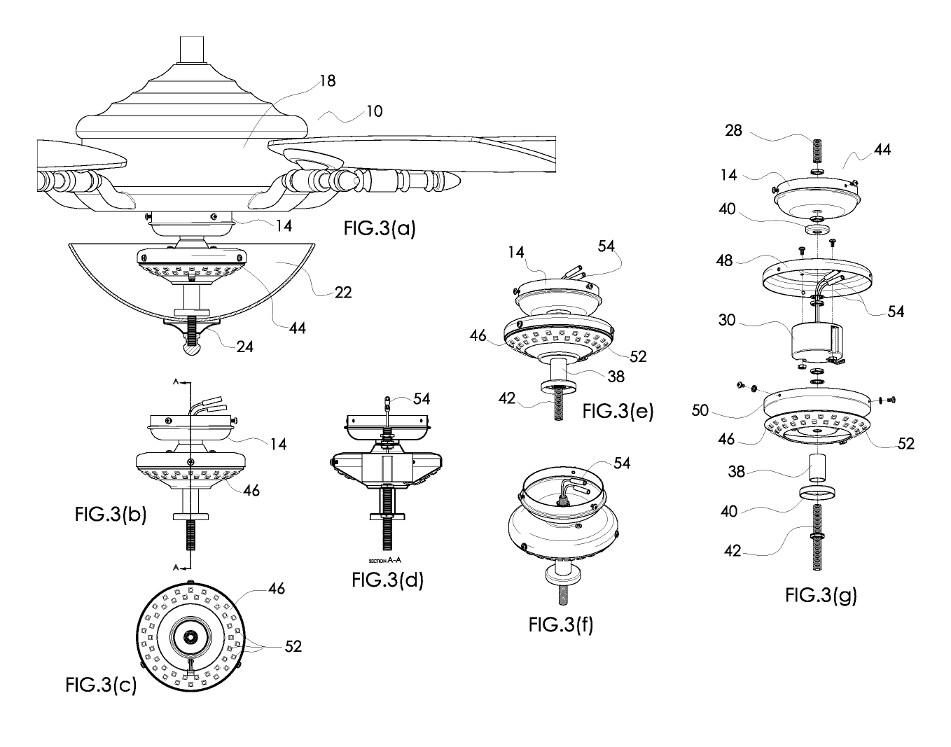

FIGS. 3(a) through 3(g) provide various views of a second embodiment of the present invention LED light kit 44. This embodiment LED light kit 44 attaches to a switch cup 14 of a slightly different design from the switch cup 16 shown in the ceiling fan 12 of FIG. 2(a). Here the switch cup 14 is larger and is held in place by radial screws.

In this embodiment, in FIGS. 3(b), 3(e) and 3(g), it can be seen that the driver housing top 48 has a simple, flat pan shape while the driver housing bottom 50 is an inverted pyramid or cone shape. Along the angled face of the inverted pyramid or cone is disposed an angled, annular ring made from an LED strip 46, with a plurality of LEDs 52 spaced about. The LED strip 46 may be flexible, or more preferably, rigid as the LEDs are mounted on a MCPCB (Metal Core Printed Circuit Board). The LED strip 46 arranged on the angled face of the driver housing bottom 46 projects light and preferably evenly illuminates the glass bowl 22 or similar light diffuser or reflector surrounding it.

The operation and construction of this embodiment is similar to the embodiment described in connection with FIGS. 2(a)-2(g) above. In FIGS. 3(b), 3(d), 3(e) and 3(f), the electrical wiring preferably uses push-in type quick connectors 54. These quick connectors 54 facilitate easy electrical connection to the quick connectors commonly found in the stator at the center of the fan motor. It can be seen that the electrical wiring from the quick connectors 54 pass through the nipple 28 and to the LED driver 30.

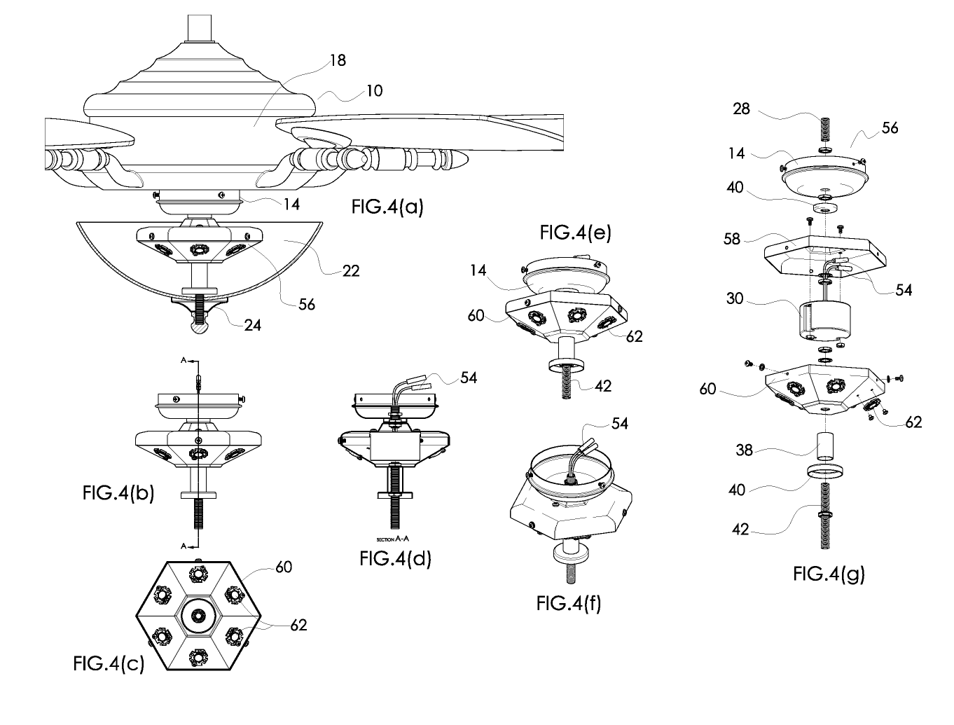

FIGS. 4(a) through 4(g) provide different views of a third exemplary embodiment 56 of the present invention universal LED light kit. Much of the same hardware in this embodiment has already been described in connection with the previous embodiments. However, the driver housing top 58 and bottom 60 together form an inverted pyramid with a hexagonal or polygonal shape as seen in the bottom view of FIG. 4(c), in contrast to the circular shapes in the previous embodiments. In this exemplary embodiment, there are six angled faces of the hexagonal shaped driver housing bottom 60. Each face includes a large, single LED 62, or a centralized cluster of LEDs, facing downward at angle, thus emitting light in those six directions thereby illuminating, transmitting through, and reflecting off of the glass bowl 22 or reflector or diffuser. The angle of each face or facet of the driver housing bottom 60 forms preferably an acute angle with the room floor; in other words, the angle is preferably less than 45 degrees, so the LEDs are pointed more downward than sideways. From empirical observations, the angled bottom improves illumination of the glass bowl 22 to better brighten the room below via direct light transmission, minimizes any blocked LEDs causing shadows or dark areas in the illumination pattern, while the light reflected from the interior of the glass bowl 22 projects upward to illuminate the ceiling which further reflects the light back down toward the room.

Other polygonal shapes for the driver housing 58, 60 are contemplated, including an octagon, pentagon, triangle, square, etc. A combination of rounded and polygonal shapes are also contemplated. More LEDs 62 may be applied to each face of the driver housing bottom 60, and their arrangement on each face may be changed to achieve a desired illumination pattern via the glass bowl 22, diffuser, or reflector. The driver housing top 58 may have additional LEDs (not shown). The driver housing 58, 60 preferably acts as a heat sink and/or radiator, and may be entirely or partially made from a heat conducting and radiating metal to keep the LED driver and LEDs relatively cool. The greater surface areas of the polygonal shaped housing 58, 60 help in cooling via thermal convection of room airflow past the heated surfaces. Via such techniques, no air fins are needed, although they may be used but might block some LED emitted light. In various alternative embodiments, all or part of the driver housing may also be made from ceramic, plastic, aluminum, zinc, a combination of such materials, or like heat dissipating materials.

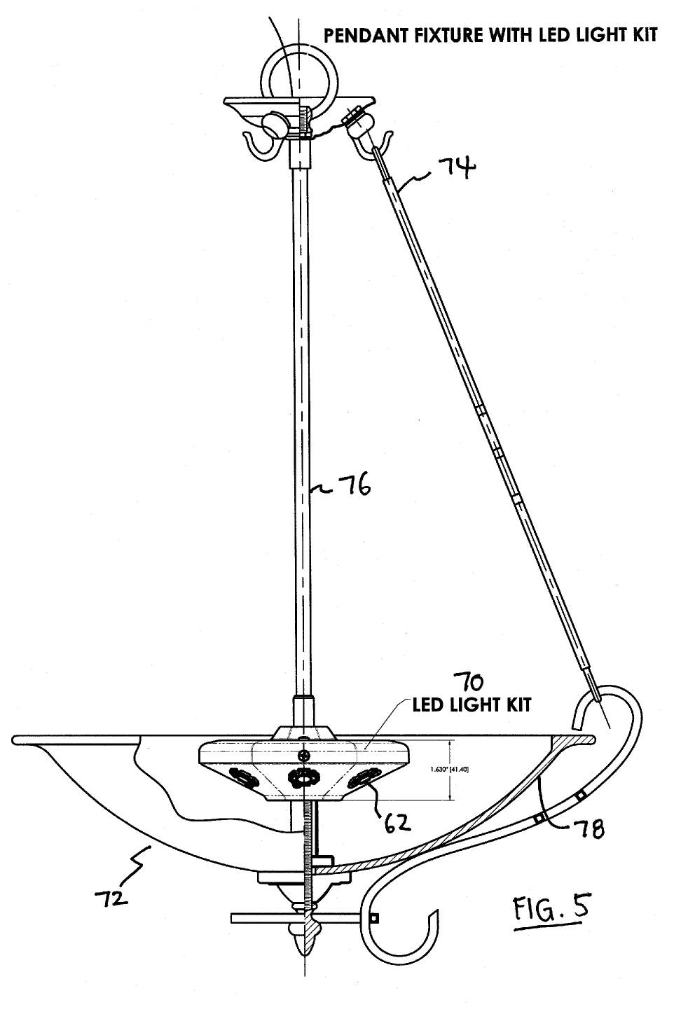

FIG. 5 shows an exemplary embodiment of the present invention LED light kit 70 when it is used to retrofit a preexisting pendant (i.e., hanging), semi-flush, ceiling mounted light fixture 72. No ceiling fan is involved in this embodiment. FIG. 5 shows the light fixture 72 in a side elevational view, partially in cross-section. The top of the light fixture 72 attaches to a commonly found electrical outlet box or junction box, and suspension wires and hardware 74 as well as a hollow center extension tube or shaft 76 hold the fixture 72 in place beneath the ceiling. An optional glass bowl 78, light diffuser, or light reflector partially covers the LED light kit 70. Electrical wiring passes from the junction box down the center extension tube or shaft 76 and into the LED light kit 70. In FIG. 5, the preexisting incandescent bulbs, halogen bulbs, CFLs, or the like have been replaced by the LED light kit 70. The LED light kit 70 may be operated via a pull chain, wireless remote transmitter, wall-mount toggle switch, etc., which is the same as with the replaced incandescent bulbs, halogen bulb, or CFLs via an optional switch cup containing an electric switch and/or circuitry mounted immediately beneath the junction box.

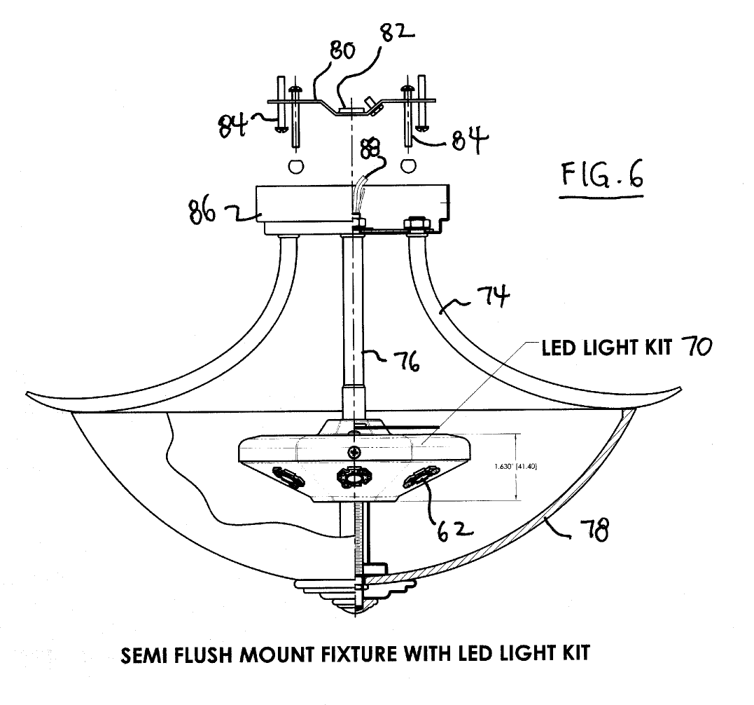

FIG. 6 is a side elevational view, partially in cross-section, of a semi-flush mount ceiling light fixture with the LED light kit 62 replacing the preexisting incandescent bulbs, halogen bulbs, CFLs, or the like. Incoming power brought in via electrical wiring 88 passes downward through the hollow extension tube or shaft 76 to power the LED light kit 62. FIG. 6 at the top shows a typical steel mounting bracket 80 commonly found attached to an outlet box or junction box (not shown) in residential homes. The threaded center hole 82 in the bracket 80 receives a threaded nipple (not shown) which may be used to help attach the light fixture to the support hardware 80, 82 in the ceiling. Bolts, clips, hooks, screws, or like fastening means 84 may be used in lieu of or in addition to the threaded nipple to secure the mounting bracket 80 to the outlet box/junction box and the support hardware in the ceiling. The wiring, mounting bracket, junction/outlet box, hole in the ceiling, etc. are hidden from view by an optional canopy 86. Operation and functioning of the LED light kit 70 are the same as described in connection with the FIG. 5 embodiment and the ceiling fan embodiments.

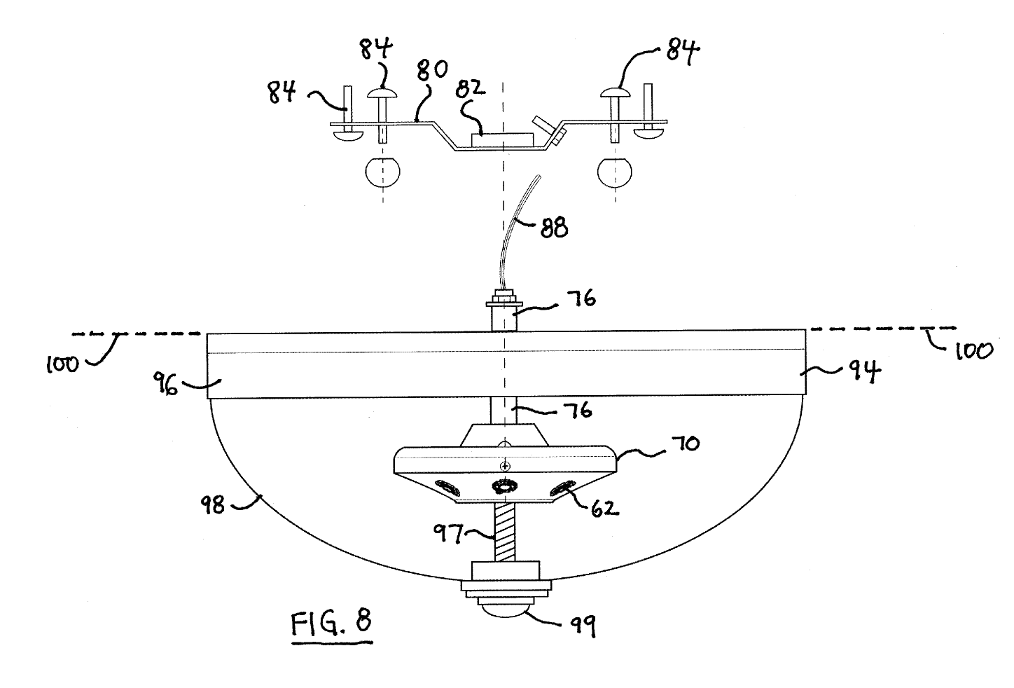

The present invention LED light kit 70 in yet another alternative embodiment may be used in a flush-mount light fixture 94 and large, flush-mount light fixtures found in large square-footage commercial establishments such as a shopping mall, restaurant, retail shop, showroom floor, etc. This is depicted in FIG. 8. The LED light kit 70 can be easily employed in such larger, industrial-sized light fixtures 94 similarly as described above in connection with FIGS. 5 and 6. As seen in the side elevational view of FIG. 8, the large size, flush-mount light fixture 94 mounts “flush” with the ceiling surface 100, shown in dashed lines, so that the fixture pan 96 abuts the ceiling 100. A translucent or transparent glass or plastic shade 98 is held on to the pan 96 by screws or hardware known in the art. At the bottom of the LED light kit 70 is a standard threaded nipple 97 that receives an optional finial 99 that also holds the shade 98 to the pan 96 in lieu of the screws or in addition to the screws.

Inside, the obsolete incandescent bulb, halogen bulb, CFL, fluorescent tube, or like light source has been replaced or may be supplemented (i.e., the electrician splicing the preexisting wiring) by the LED light kit 70. All of the electrical and hardware for the incandescent bulb, halogen bulb, CFL, etc. can be adapted for use with the LED light kit 70. Electrical wiring 88 from the outlet box is passed down through center hole 82 of the mounting bracket 80 through a hollow, threaded nipple 76 and into the LED light kit 70. At its top end the nipple 76 threads into the mounting bracket center hole 82, and threads into the LED light kit 70 at its bottom end. The mounting bracket 80, bolts 84, outlet box, wiring, ceiling hole, etc. are all contained above the ceiling surface 100 and hidden from view below when the light fixture 94 is installed. Other alternative embodiment LED light kits 20, 44, 56 may be used here.

Because large square-footage establishments like a shopping mall, hotel lobby, commercial office space, convention hall floor, restaurant, etc., require many, many light fixtures with a lot of floor area to be illuminated, electricity consumption and burned out bulb replacement are always great expenses. Once the LED light kit 70 is installed, however, the LEDs 62 replace the inefficient, high energy consuming incandescent bulbs, halogen bulbs, CFLs, etc., vastly improving the electricity savings while still providing the same or better level of illumination over the same large floor space. Since the LED light kits last so much longer than an incandescent or halogen bulb or CFL until they burn out and are replaced, the facilities maintenance department can save on manpower and replacement bulb inventory costs.

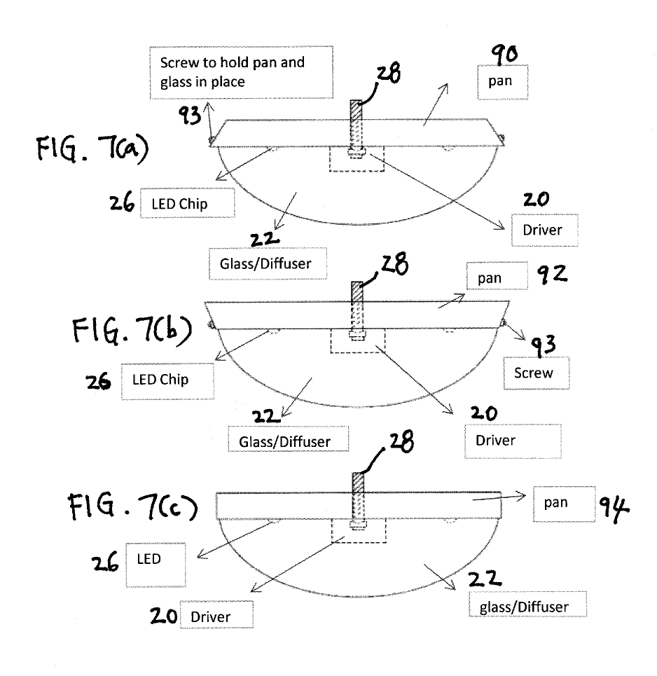

In various alternative embodiments of FIGS. 7(a)-(c), the present invention LED light kit may be adapted for use with an outdoor fan. In such outdoor applications as in a gazebo or patio, weather conditions such as rain, hail, ice, dew, snow, insects, dust, etc., come into play. FIGS. 7(a)-7(c) show various embodiments of an LED light kit 20 adapted for use with an outdoor fan. In these exemplary embodiments, the LED light kit 20 is installed, for example, to the ceiling fan 12 from FIG. 2(a) using the nipple 28 to connect with the switch cup 16 of the fan 12. An optional pan 90, 92, 94 is added to cover or enclose the open top of the diffuser, reflector, or glass bowl 22, from the environmental elements. The pans 90, 92, 94 may have different slopes on their edges for accumulated dust, snow, ice, rain water, etc. to slough off, and can be made from plastic, metal, or ceramic. There may be a rubber or felt gasket, or glue bead lining the circumferential lip of the pan 90, 92, 94 to seal it with the rim of the glass bowl 22, diffuser, or reflector for some level of weatherproofing and creating an insect or rodent barrier. Optional fasteners 93 such as screws, bolts, flip locks, snaps, or rivets secure the pan 90, 92, 94 to the diffuser, reflector, or glass bowl 22. Thus, the electrical components such as the LED light kit 20 and LEDs 26 are enclosed and isolated from the outdoor elements by the glass bowl 22 and pan 90, 92, 94. Pans of varying shapes and sizes other than that shown to fit the varying shapes and sizes of the bowl, diffuser or reflector are contemplated. The LED light kits 44, 56, 70 and their alternative embodiments may be used in the FIGS. 7(a)-7(c) outdoor application as well.

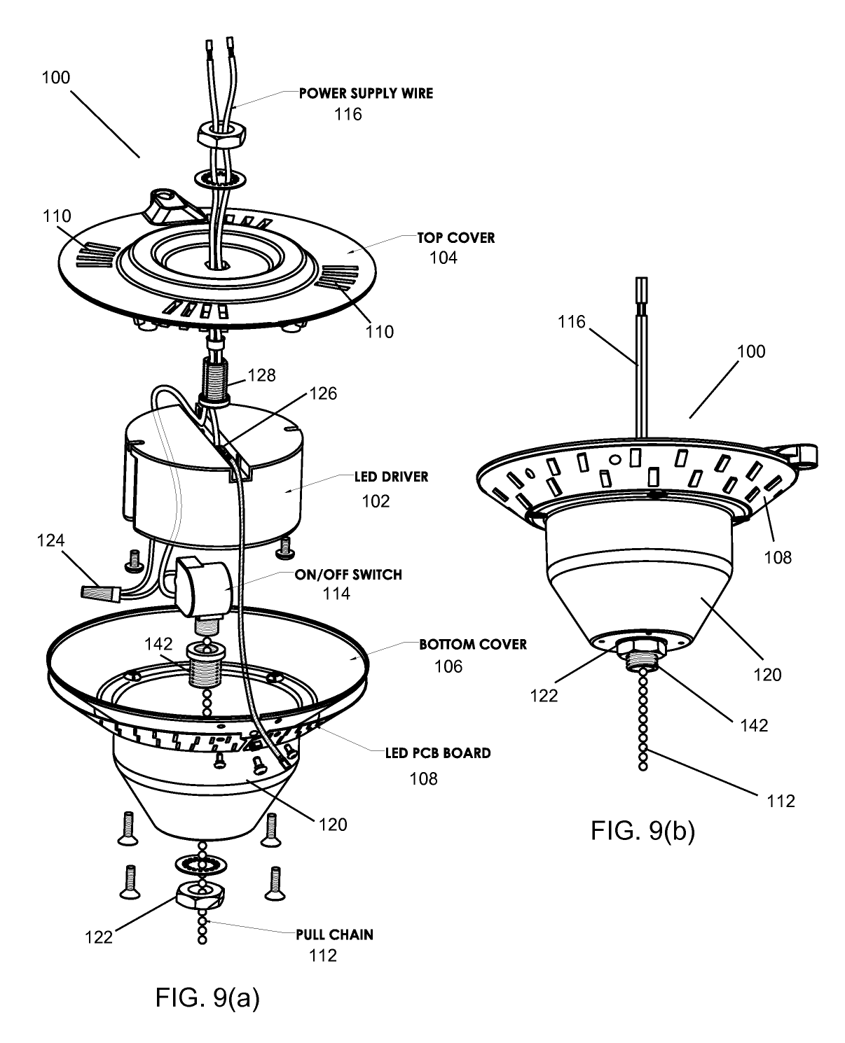

FIGS. 9(a) and 9(b) show another alternative embodiment of the present invention LED light kit 100. As seen in the exploded view of FIG. 9(a), the kit includes a LED driver 102 that is at least partially enclosed by a top cover 102 and a bottom cover 106 forming a housing. An LED printed circuit board (PCB) 108 is mounted to the underside of the bottom cover 106 and is powered by the LED driver 102. AC line in electrical power originally intended for the incandescent light bulbs, halogen bulbs, CFLs, etc., are amplified, modulated, and rectified as needed through conventional processes via the LED driver 102 to adapt it to powering the LEDs 108. In this exemplary embodiment, the LED driver 102 connects to the power supply wires 116 and also passes those wires 116 around the sides of the driver housing to the on/off switch 114 below. Twist-on wire connectors 124 may be used for making quick electrical connections. One or more optional channels 126 formed into the LED driver case or enclosure neatly receive the wiring therein. In an alternative embodiment, the case enclosing the LED driver 102 may have a central opening to connect to the power supply wires and also to pass the wires through that center opening to the on/off switch below. That center opening may also be used to pass a pull chain therethrough.

The bottom cover 106 has a generally truncated cone shape with an angled underside to which the LED PCB board 108 is attached. Further, the bottom cover 106 preferably includes a chamber 120 to contain the LED driver 102 and on/off switch 114. The angled underside advantageously presents the illuminated LEDs to project light downward into the room below in an even, 360-degree pattern, without casting a shadow or creating dark areas in the light visible by a consumer from below due to partially obstructed LEDs.

The LED PCB board 108 is electrically connected to the LED driver 102. The number, placement, density, arrangement, color, Kelvin temperature, wattage, intensity, lumens output, etc. of the LED chips on the PCB board 108 are chosen to fit the lighting conditions desired by the customer, whether used for lighting a shopping mall, a restaurant, a residential home, a hotel lobby or guest room, showroom floor, etc. The LEDs on the board 108 may optionally be covered by a transparent or translucent lens (not shown) for protection of the LEDs and to diffuse or filter the emitted light. As mentioned earlier, both or either the bottom cover 106 and the top cover 104 may be made from a thermally conductive, thermal radiating material including a metal, a plastic, or the like, to cool the LED driver 102 and the LEDs on the PCB board 108. The top cover 104 further includes optional cooling vents 110. The vents 110 are elongated shape, through-holes formed into the housing and arranged radially. The vents 110 enable convection and radiation of heat from the LED driver 102 into the ambient air. Screws, clips, hooks, glue, and other fastening means known in the art may be used to hold the top and bottom covers 104, 106 together.

As with other embodiments, an upper nipple 128 is used to funnel the building's power supply wires 116 down to the LED driver 102, and also to mount the entire LED light kit 100 to a ceiling light fixture which in turn mounts to a junction box or outlet box located in the ceiling, or to the light cup of a ceiling fan. A lower nipple 142 receives a chain pull, cable, or chord 112 connected to an on/off switch 114 used to power the LED light kit 100 on or off, and/or to control the ceiling fan operations. A nut, finial, or fastening means 122 threads or otherwise attaches onto the bottom cover 106 to hold the entire assembly together.

While particular forms of the invention have been illustrated and described, it will be apparent that various modifications can be made without departing from the spirit and scope of the invention. It is contemplated that components from one embodiment may be combined with components from another embodiment.

What is claimed is:

1. A LED light kit adapted for use with a ceiling light fixture or a ceiling fan, comprising:
a housing having a top and a bottom, wherein the bottom includes an angled bottom surface with a center opening therethrough;
a LED board containing LEDs mounted to the angled bottom surface;
a LED driver disposed inside the housing and powering the LED board;
an upper fastening means disposed at the top of the of the housing;
a lower threaded, hollow nipple disposed at the bottom of the housing; and
electrical wiring passing through the upper fastening means and connecting to the LED driver.

2. The LED light kit of claim 1, wherein the LED light kit further comprises a diffuser disposed beneath housing and is attached to the lower nipple.

3. The LED light kit of claim 2, wherein the LED light kit further comprises a pan top engaging the diffuser containing the light kit therein.

4. The LED light kit of claim 1, wherein the LED light kit further comprises a pull cable and a power switch controlling the LED driver, wherein the pull chain passes through the lower nipple.

5. The LED light kit of claim 1, wherein the LED light kit further comprises a LED board containing LEDs disposed at the top of the housing.

6. The LED light kit of claim 1, wherein the top of the housing is angled.

7. The LED light kit of claim 1, wherein the angled bottom surface of the housing includes an acute angle.

8. The LED light kit of claim 1, wherein the housing bottom includes a circular shape.

9. The LED light kit of claim 1, wherein the housing bottom includes a polygonal shape.

10. The LED light kit of claim 1, wherein the housing includes a material that dissipates and conducts heat away from the LED driver.

11. A LED light kit adapted for use with a ceiling light fixture attached to an electrical outlet box or a ceiling fan including a switch cup, comprising:
a housing including a heat dissipating material, having a top and a truncated cone shaped bottom, wherein the cone bottom includes an angled bottom surface with a center opening therethrough;
a LED board having a plurality of spaced apart LEDs, mounted to the angled bottom surface facing away from the housing;
a LED driver disposed inside the housing and powering the LED board;
an upper attachment means disposed at the top of the of the housing connected to at least one of the outlet box and the switch cup;
a lower threaded, hollow nipple disposed at the bottom of the housing; and
electrical wiring passing through the upper attachment means and connecting at least one of the outlet box and switch cup to the LED driver.

12. The LED light kit according to claim 11, wherein the light kit further comprises a bowl shaped reflector disposed underneath the LED light kit.

13. The LED light kit according to claim 11, wherein the housing includes a cooling vent opening.

14. The LED light kit according to claim 11, wherein the LED driver includes a case, and the case includes a center opening.

15. The LED light kit according to claim 11, wherein the upper attachment means includes at least one of a hollow, threaded nipple; mechanical fasteners; and an extension tube.

16. A LED light kit adapted for use with a ceiling light fixture attached to an electrical outlet box or a ceiling fan including a switch cup, comprising:
a housing having a top and a bottom;
a LED board having a plurality of spaced apart LEDs, mounted at least to one of the top and the bottom of the housing;
a LED driver disposed inside the housing and powering the LED board;
an upper attachment means disposed at the top of the of the housing connected to at least one of the outlet box and the switch cup;
a lower threaded nipple disposed at the bottom of the housing; and
electrical wiring passing through the upper attachment means and connecting at least one of the outlet box and switch cup to the LED driver.

17. The LED light kit of claim 16, wherein the upper attachment means includes a hollow, threaded nipple.

18. The LED light kit of claim 16, wherein the light kit further comprises a bowl shaped diffuser disposed proximate the LED light kit.
